(19) United States
(12) Patent Application Publication
(10) Pub. No.: US 2024/0322181 A1
(43) Pub. Date: Sep. 26, 2024

(54) CARBON NANOTUBE DISPERSED LIQUID FOR LITHIUM ION BATTERY ELECTRODES

(71) Applicant: Kansai Paint Co., Ltd., Amagasaki-shi, Hyogo (JP)

(72) Inventors: Haruhiko Okiyama, Hiratsuka-shi (JP); Yuji Hirose, Hiratsuka-shi (JP); Keiichi Katayama, Hiratsuka-shi (JP)

(73) Assignee: Kansai Paint Co., Ltd., Amagasaki-shi, Hyogo (JP)

(21) Appl. No.: 18/578,611

(22) PCT Filed: Jul. 13, 2022
(86) PCT No.: PCT/JP2022/027496

§ 371 Date: Jan. 11, 2024

(30) Foreign Application Priority Data
Jul. 13, 2021 (JP) 2021-115519

(51) Int. Cl. H01M 4/62; C01B 32/174; H01M 4/13; H01M 10/0525

(52) U.S. Cl. CPC H01M 4/625; C01B 32/174; H01M 4/13; H01M 10/0525; C01B 2202/06; C01B 2202/24; C01B 2202/32; C01B 2202/34; C01B 2202/36; C01P 2002/82; C01P 2004/133; C01P 2004/61; C01P 2004/62; C01P 2004/64; C01P 2006/12; C01P 2006/22; C01P 2006/40

(57) ABSTRACT

Provided is a carbon nanotube dispersed liquid for lithium ion battery electrodes, containing a dispersion resin (A), carbon nanotubes (B), and water, in which the dispersion resin (A) contains a polar functional group-containing resin (a).

### TECHNICAL FIELD

The present invention relates to a carbon nanotube dispersed liquid for lithium ion battery electrodes.

Priority is claimed on Japanese Patent Application No. 2021-115519, filed on Jul. 13, 2021, the content of which is incorporated herein by reference.

### BACKGROUND ART

A lithium ion secondary battery is a type of secondary batteries, in which lithium ions in an electrolyte are responsible for electrical conduction in the secondary battery.

The lithium ion secondary battery has excellent characteristics such as high energy density, excellent charge energy retention characteristics, and a so-called memory effect, by which the apparent capacity thereof is reduced, being low. Accordingly, the lithium ion secondary battery has been used in a wide range of fields such as mobile phones, smart phones, personal computers, hybrid vehicles, and electric vehicles.

Here, the lithium ion secondary battery mainly includes a positive electrode plate, a negative electrode plate, and the like. The above-described positive electrode plate and negative electrode plate each have an electrode layer (electrode composite material layer) formed on a surface of an electrode core material (also referred to as a current collector). The electrode layer can be manufactured by coating a surface of the electrode core material with a dispersed liquid in which an electrode active material is mixed into a carbon nanotube dispersed liquid containing a conductive aid (carbon nanotube or the like), a binder, and a solvent, and then drying the dispersed liquid.

Since the manufacturing of the electrode layer as described above is carried out by coating the surface of the electrode core material with a carbon nanotube dispersed liquid for lithium ion battery electrodes, which contains an electrode active material, it is required that the carbon nanotube dispersed liquid has a low viscosity.

Under such circumstances, Patent Document 1 discloses a multi-layer carbon nanotube aqueous dispersed liquid in which a multi-layer carbon nanotube is dispersed in an aqueous solution containing an anionic surfactant (A), a nonionic surfactant (B), and an anionic surfactant (C) which is a different compound from the anionic surfactant (A). In addition, Patent Document 2 discloses a carbon nanotube aqueous dispersed liquid consisting of (a) polysaccharides, (b) a carbon nanotube, and (c) a water-soluble compound having a perfluoroalkyl group.

However, in these inventions, dispersibility or storage stability of the carbon nanotube may be deteriorated, and in a case where a large amount of dispersant is added, it affects a battery performance (internal resistance and capacity), so that there is a limit to the blending amount of the dispersant. Therefore, a dispersant capable of reducing a viscosity of a conductive paste with a small blending amount is desired.

### CITATION LIST

### Patent Documents

### [Patent Document 1]

PCT International Publication No. WO2010/041750

### [Patent Document 2]

Japanese Unexamined Patent Application, First Publication No. 2012-56788

### SUMMARY OF INVENTION

### Technical Problem

An object of the present invention is to provide a carbon nanotube dispersed liquid for lithium ion battery electrodes, which has a viscosity easily applied even in a case where a blending amount of a dispersion resin is relatively small.

### Solution to Problem

As a result of intensive studies under such circumstances, the present inventors have found that the above-described problems can be solved by using a dispersion resin (A) including a certain amount of a polar functional group-containing resin (a). The present invention is based on such a novel finding.

Accordingly, the present invention provides the following sections.

[1] A carbon nanotube dispersed liquid for lithium ion battery electrodes, containing a dispersion resin (A), carbon nanotubes (B), and water, in which the dispersion resin (A) contains a polar functional group-containing resin (a).

[2] The carbon nanotube dispersed liquid for lithium ion battery electrodes according to [1], in which the polar functional group-containing resin (a) is an ionic polyvinyl alcohol resin (a1) and/or carboxymethyl celluloses (a2).

[3] The carbon nanotube dispersed liquid for lithium ion battery electrodes according to [2], in which the ionic polyvinyl alcohol resin (a1) is a sulfonic acid-modified polyvinyl alcohol resin (a1-1) and/or a carboxylic acid-modified polyvinyl alcohol resin (a1-2).

[4] The carbon nanotube dispersed liquid for lithium ion battery electrodes according to [3], in which the ionic polyvinyl alcohol resin (a1) is the sulfonic acid-modified polyvinyl alcohol resin (a1-1), and a proportion of a monomer unit having a sulfonic acid group in the sulfonic acid-modified polyvinyl alcohol resin (a1-1) is 0.1% to 30% by mass with respect to a total mass of monomer units constituting the ionic polyvinyl alcohol resin (a1).

[5] The carbon nanotube dispersed liquid for lithium ion battery electrodes according to [2], in which a saponification degree of the ionic polyvinyl alcohol resin (a1) is 50 to 100 mol %.

[6] The carbon nanotube dispersed liquid for lithium ion battery electrodes according to [1], in which a BET specific surface area of the carbon nanotubes (B) is 50 to 1,800 m²/g, and in a Raman spectrum of the carbon nanotubes (B), in a case where a maximum peak intensity in a range of 1560 to 1600 cm⁻¹ is defined as G and a maximum peak intensity in a range of 1310 to 1350 cm⁻¹ is defined as D, a G/D ratio is 5 to 200.

[7] The carbon nanotube dispersed liquid for lithium ion battery electrodes according to [1], in which, in a Bode plot obtained by an impedance measurement, in which reactance is plotted on a vertical axis and frequency is plotted on a horizontal axis, a minimal value of reactance exists in a frequency range of 170 to 600 kHz, and the minimum value of the reactance existing in the frequency range of 170 to 600 kHz is 1.8 times or more a value of reactance at a frequency of 1 kHz.

[8] A carbon nanotube dispersed liquid for lithium ion battery electrodes, containing:
a dispersion resin (A);
carbon nanotubes (B); and
water,
in which the dispersion resin (A) contains a polar functional group-containing resin (a), and
in a Bode plot obtained by an impedance measurement, in which reactance is plotted on a vertical axis and frequency is plotted on a horizontal axis, a minimal value of reactance exists in a frequency range of 170 to 600 KHz.

[9] The carbon nanotube dispersed liquid for lithium ion battery electrodes according to [8], in which, in the Bode plot obtained by the impedance measurement, in which reactance is plotted on a vertical axis and frequency is plotted on a horizontal axis, a minimal value of reactance exists in the frequency range of 170 to 600 kHz, and the minimum value of the reactance existing in the frequency range of 170 to 600 kHz is 1.8 times or more a value of reactance at a frequency of 1 kHz.

[10] A carbon nanotube dispersed liquid for lithium ion battery electrodes, which is obtained by further blending an electrode active material to the carbon nanotube dispersed liquid according to any one of [1] to [9].

[11] An electrode layer for a lithium ion battery, which is formed from the carbon nanotube dispersed liquid according to [10].

[12] An electrode for a lithium ion battery, including the electrode layer for a lithium ion battery according to and a metal current collector.

[13] A lithium ion battery including the electrode for a lithium ion battery according to [12], as a positive electrode and/or a negative electrode.

[14] A lithium ion battery including the electrode for a lithium ion battery according to [12], as a positive electrode.

### Advantageous Effects of Invention

The dispersion resin (A) blended in the carbon nanotube dispersed liquid for lithium ion battery electrodes according to the aspect of the present invention can sufficiently reduce a viscosity of a paste with a relatively smaller blending amount than a pigment dispersion resin used in the carbon nanotube dispersed liquids for lithium ion battery electrodes of the related art, and has favorable storage stability.

### BRIEF DESCRIPTION OF DRAWINGS

FIG. 1 is an explanatory diagram representing a correlation between a degree of structure growth of carbon nanotubes (B) and a Bode plot.

FIG. 2 is an explanatory diagram representing a correlation between a particle size distribution of aggregates of primary particles of the carbon nanotubes (B) and a ratio of a minimum value (X) to a value (Y).

FIG. 3 is a cross-sectional view representing an example of an electrode for a lithium ion battery, having an electrode layer for a lithium ion battery.

FIG. 4 is a cross-sectional view representing an example of a lithium ion battery.

### DESCRIPTION OF EMBODIMENTS

A detailed description will be given of embodiments for implementing the present invention.

It should be understood that the present invention is not limited to the following embodiments, but includes various modified examples implemented in a range not departing from the gist of the present invention.

In addition, in the present specification, “carbon nanotube dispersed liquid for lithium ion battery electrodes” may be abbreviated as “carbon nanotube dispersed liquid”, and “carbon nanotube” may be abbreviated as “CNT”.

### <<Carbon Nanotube Dispersed Liquid for Lithium Ion Battery Electrodes>>

The present invention relates to a carbon nanotube dispersed liquid for lithium ion battery electrodes, containing a dispersion resin (A), carbon nanotubes (B), and water, in which the dispersion resin (A) contains a polar functional group-containing resin (a).

The “carbon nanotube dispersed liquid” in the present application can also be referred to alternatively as “carbon nanotube aqueous dispersed liquid” because the carbon nanotube dispersed liquid always contains water as a solvent.

### <Dispersion Resin (A)>

The dispersion resin (A) which can be used in the present invention contains a polar functional group-containing resin (a).

<Polar Functional Group-Containing Resin (a)>

The above-described polar functional group-containing resin (a) is a resin containing a highly polar functional group, and the polar functional group is an ionic and/or nonionic functional group. As the ionic functional group, for example, acidic functional groups such a sulfonic acid group, a carboxyl group, a sulfuric acid group, a phosphonic acid group, a phosphoric acid group, a phosphinic acid group, and a mercapto group; and basic functional groups such as a primary, secondary, or tertiary amino group, an ammonium group, an imino group, and nitrogen-containing heterocyclic ring groups including pyridine, pyrimidine, pirazine, imidazole, triazole, and the like are exemplary examples. As the nonionic functional group, for example, an amide group, a polyoxyalkylene group, a pyrrolidone group, and the like are exemplary examples.

Among these, as the polar functional group-containing resin (a), an ionic polar functional group-containing resin (a) is preferable, an ionic polyvinyl alcohol resin (a1) and/or carboxymethyl celluloses (a2) are more preferable, and carboxymethyl celluloses (a2) are still more preferable.

[Ionic Polyvinyl Alcohol Resin (a1)]

The above-described ionic polyvinyl alcohol resin (a1) is a polyvinyl alcohol resin having the above-described ionic functional group. Among these, as the ionic functional group, it is preferable to have an acidic functional group, it is more preferable to have a sulfonic acid group or a carboxyl group, and it is particularly preferable to have a sulfonic acid group.

The above-described acidic functional group may be in a form of a free acid, or may be in a form of an alkali metal salt such as a sodium salt, an ammonium salt, or the like.

As the ionic polyvinyl alcohol resin (a1), a sulfonic acid-modified polyvinyl alcohol resin (a1-1) and/or a carboxylic acid-modified polyvinyl alcohol resin (a1-2) is preferable, and a sulfonic acid-modified polyvinyl alcohol resin (a1-1) is more preferable.

(Sulfonic Acid-Modified Polyvinyl Alcohol Resin (a1-1))

For example, the above-described sulfonic acid-modified polyvinyl alcohol resin (a1-1) can be produced by the following methods.
(1) method in which a compound containing a sulfonic acid group and a polymerizable unsaturated group is copolymerized with a fatty acid vinyl ester such as vinyl acetate, and the obtained polymer is further saponified
(2) method in which a Michael addition is performed on a polyvinyl alcohol with vinylsulfonic acid, 2-acrylamide-2-methylpropanesulfonic acid, or the like
(3) method in which a polyvinyl alcohol is heated in a sulfuric acid compound solution (a sulfuric acid aqueous solution, a sodium sulfite aqueous solution, or the like)
(4) method in which a polyvinyl alcohol is acetalized with a sulfonic acid group-containing aldehyde compound
(5) method in which a polyvinyl alcohol is polymerized coexistence with, as a chain transfer agent, an alcohol having a sulfonic acid group or a compound having a functional group such as aldehyde and thiol

Any of the production methods can be suitably used, but the method (1) in which a compound containing a sulfonic acid group and a polymerizable unsaturated group is copolymerized with a fatty acid vinyl ester such as vinyl acetate, and the obtained polymer is further saponified is particularly preferable.

As the above-described compound containing a sulfonic acid group and a polymerizable unsaturated group, any compound capable of copolymerizing with the fatty acid vinyl ester can be used without particular limitation, and specifically, for example, olefin sulfonic acids such as vinylsulfonic acid, isoprene sulfonic acid, ethylene sulfonic acid, allylsulfonic acid, and methallylsulfonic acid; sulfoalkyl maleates such as sodium sulfopropyl 2-ethylhexyl maleate, sodium sulfopropyl tridecyl maleate, and sodium sulfopropyl eicosyl maleate; sulfoalkyl (meth)acrylamides such as 2-(meth)acrylamide-2-methylpropanesulfonic acid and sodium N-sulfoisobutylene acrylamide; sulfoalkyl (meth)acrylates such as 3-methacryloyloxypropanesulfonic acid, 4-methacryloyloxybutanesulfonic acid, 3-methacryloyloxy-2-hydroxypropanesulfonic acid, 3-acryloyloxypropanesulfonic acid, sulfoethyl (meth)acrylate, sodium methacylate-4-styrene sulfonate, and sodium 2-sulfoethylacrylate; allyloxybenzenesulfonic acid, methallyloxybenzenesulfonic acid, styrenesulfonic acid, an ammonium salt of oleyl 2-hydroxy-[3-allyloxy]-propyl sulfosuccinate; and the like are exemplary examples. These can be used alone or in a combination of two or more.

A proportion of a polymerizable unsaturated monomer unit having a sulfonic acid group in the sulfonic acid-modified polyvinyl alcohol resin is preferably 0.1% to 30% by mass and more preferably 0.2% to 10% by mass with respect to the total mass of monomer units constituting the sulfonic acid-modified polyvinyl alcohol resin.

In the present invention, the “proportion of a monomer unit having a sulfonic acid group in the resin (a1-1)” refers to a proportion of a monomer having a sulfonic acid group in a monomer mixture which is to be a raw material of the resin (a1-1). Therefore, the “the proportion of the monomer having a sulfonic acid group in the resin (a1-1) is 0.1% to 30% by mass with respect to the total mass of monomer units constituting the resin (a1-1)” means that the resin (a1-1) is a copolymer of a raw material monomer which includes 0.1% to 30% by mass of the monomer having a sulfonic acid group with respect to the total mass of the raw material monomer. Similarly, “proportion of a monomer unit X in a resin Y” refers to a proportion of the monomer X in a monomer mixture which is to be a raw material of the resin Y. Therefore, the “the proportion of a polymerizable unsaturated group-containing monomer unit X in a resin Y is a % by mass with respect to the total mass of monomer units constituting the resin Y” means that the Y is a copolymer of a raw material monomer which includes a % by mass of the monomer X with respect to the total mass of the raw material monomer. In addition, in a case where hydrolysis is performed by saponification, the amount is converted into a mass after the saponification.

As the fatty acid vinyl ester copolymerized with the above-described compound containing a sulfonic acid group and a polymerizable unsaturated group, for example, vinyl formate, vinyl acetate, vinyl propionate, vinyl butyrate, vinyl caprate, vinyl caprylate, vinyl caproate, vinyl laurate, vinyl myristate, vinyl palmitate, vinyl stearate, vinyl pivalate, vinyl octylate, vinyl monochlorate, vinyl benzoate, vinyl cinnamate, vinyl crotonate, divinyl adipate, and derivatives thereof are exemplary examples, and these can be used alone or in a combination of two or more. Among these, vinyl acetate is preferable.

As other copolymerizable unsaturated monomers, for example, olefin monomers such as ethylene and propylene; (meth)acryloyl group-containing monomers such as alkyl (meth)acrylate, 2-hydroxyethyl (meth)acrylate, and glycidyl (meth)acrylate; allyl ethers such as allyl glycidyl ether; halogenated vinyl compounds such as vinyl chloride, vinylidene chloride, and vinyl fluoride; vinyl ethers such as alkyl vinyl ether and 4-hydroxyvinyl ether; and the like are exemplary examples. These can be used alone or in a combination of two or more.

A degree of polymerization of the sulfonic acid-modified polyvinyl alcohol resin (a1-1) is preferably 100 to 4,000 and more preferably 100 to 3,000.

In the present specification, the degree of polymerization can be calculated based on a molecular weight of the resin.

The above-described molecular weight is a value in terms of polystyrene molecular weight, which is determined from the retention time (retention volume) measured by gel permeation chromatography (GPC) based on the retention time (retention volume) of a standard polystyrene with a known molecular weight measured under the same conditions. Specifically, the measurement is performed using a gel permeation chromatography apparatus “HLC8120GPC” (product name, manufactured by Tosoh Corporation) together with four columns “TSKgel G-4000HXL,” “TSKgel G-3000HXL,” “TSKgel G-2500HXL,” and “TSKgel G-2000HXL,” (product names, all manufactured by Tosoh Corporation) under the following conditions, mobile phase: tetrahydrofuran, measurement temperature: 40° C., flow rate: 1 mL/min, and detector: RI.

A saponification degree of the sulfonic acid-modified polyvinyl alcohol resin (a1-1) is preferably in a range of 60 to 100 mol %, more preferably in a range of 70 to 100 mol %, still more preferably in a range of 80 to 100 mol %, and particularly preferably in a range of 90 to 99.9 mol %.

In the present specification, the saponification degree can be measured by a measurement method in accordance with JIS K 6726-1994 or a measurement method obtained by modifying the measurement method based on resin composition.

Generally, solubility in an aqueous solvent is deteriorated in a case where the saponification degree is low (low polarity). In addition, the solubility in an aqueous solvent is favorable in a case where the saponification degree is high (high polarity), but the resin is easily dissolved in the aqueous solvent, so that adsorption to the carbon nanotubes is poor, a steric repulsive layer cannot be formed, and dispersibility or storage stability of the dispersed liquid is deteriorated. However, in the present invention, as the reason why the ionic polyvinyl alcohol resin (sulfonic acid-modified polyvinyl alcohol resin, carboxylic acid-modified polyvinyl alcohol resin, or the like) is effective in dispersibility or storage stability of the carbon nanotube dispersed liquid, it is considered that, while ensuring the solubility in an aqueous solvent by the main chain of the resin having moderate polarity, introduction of the specific ionic functional group in the side chain of the resin can improve the adsorption to the carbon nanotubes, which is capable of achieving both solubility in an aqueous solvent and adsorption to pigments.

As a polymerization method for the above-described resin (a1-1), for example, the resin (a1-1) can be produced by a known polymerization method itself or a method of performing solution polymerization in an organic solvent, but the present invention is not limited thereto. Alternatively, emulsion polymerization, suspension polymerization, or the like may be performed. In a case of performing the solution polymerization, the polymerization may be continuous polymerization or batch polymerization, and the monomers may be charged in one portion, may be charged in portions, or may be charged continuously or intermittently.

A polymerization initiator used in the solution polymerization is not particularly limited, and specifically, known radical polymerization initiators, for example, azo compounds such as azobisisobutyronitrile, azobis-2,4-dimethylvaleronitrile, and azobis(4-methoxy-2,4-dimethylvaleronitrile); peroxides such as acetyl peroxide, benzoyl peroxide, lauroyl peroxide, acetylcyclohexylsulfonyl peroxide, and 2,4,4-trimethylpentyl-2-peroxyphenoxyacetate; percarbonate compounds such as diisopropyl peroxydicarbonate, di-2-ethylhexyl peroxydicarbonate, and diethoxyethyl peroxydicarbonate; perester compounds such as t-butylperoxy neodecanoate, cumylperoxy neodecanoate, and t-butylperoxy neodecanoate; azobis dimethylvaleronitrile; azobis methoxyvaleronitrile; and the like can be used.

The polymerization reaction temperature is not particularly limited, but can be usually set in a range of approximately 30° C. to 200° C.

Conditions for the saponification are not particularly limited, and the saponification can be performed by a known method. For example, the saponification can be performed by hydrolyzing an ester moiety in the molecule in the presence of an alkali catalyst or an acid catalyst in an alcohol solution such as methanol.

As the alkali catalyst, for example, hydroxides of an alkali metal, such as sodium hydroxide, potassium hydroxide, sodium methylate, sodium ethylate, and potassium methylate; alcoholates; and the like can be used. As the acid catalyst, for example, an inorganic acid aqueous solution such as hydrochloric acid and sulfuric acid, an organic acid such as p-toluenesulfonic acid, and the like can be used, and it is desirable to use sodium hydroxide.

The temperature of the saponification reaction is not particularly limited, but is preferably in a range of 10° C. to 70° C. and more preferably in a range of 30° C. to 40° C. The reaction time is not particularly limited, but is desirably in a range of 30 minutes to 3 hours.

The above-described resin (a1-1) can be formed into a solid or a resin solution replaced by any solvent, which is obtained by desolvating the solution and/or replacing the solvent after completion of the synthesis.

As the desolvation method, the solution may be desolvated by heating under normal pressure, or may be desolvated under reduced pressure.

As the method of solvent replacement, a replacement solvent may be introduced at any stage before, during, or after the desolvation.

(Carboxylic Acid-Modified Polyvinyl Alcohol Resin (a1-2))

The above-described carboxylic acid-modified polyvinyl alcohol resin (a1-2) contains a carboxyl group, in which a saponification degree is preferably 60 to 100 mol %, more preferably in a range of 70 to 100 mol %, still more preferably in a range of 80 to 100 mol %, and particularly preferably in a range of 90 to 99.9 mol %.

A degree of polymerization of the above-described carboxylic acid-modified polyvinyl alcohol resin (a1-2) is preferably 100 to 4,000 and more preferably 100 to 3,000.

As a polymerization method for the above-described carboxylic acid-modified polyvinyl alcohol resin (a1-2), the carboxylic acid-modified polyvinyl alcohol resin (a1-2) can be obtained by a known polymerization method itself, for example, a method of copolymerizing a compound having a carboxyl group and a polymerizable unsaturated group with a fatty acid vinyl ester such as vinyl acetate, and further saponifying the obtained polymer.

In addition, it is also possible to introduce (contain) a carboxyl group by modifying a polyvinyl alcohol resin after synthesizing.

A proportion of a polymerizable unsaturated monomer unit having a carboxyl group is preferably 0.1% to 30% by mass, more preferably 0.2% to 10% by mass, and still more preferably 0.2% to 5% by mass with respect to the total mass of monomer units constituting the above-described carboxylic acid-modified polyvinyl alcohol resin (a1-2).

Regarding the synthesizing method and the like of the resin (a1-2), the method described for the resin (a1-1) can be suitably used.

(Polyvinyl Alcohol Resin (a1-3) Having Other Ionic Functional Groups)

As the above-described ionic polyvinyl alcohol resin (a1), in addition to the above-described sulfonic acid-modified polyvinyl alcohol resin (a1-1) and/or carboxylic acid-modified polyvinyl alcohol resin (a1-2), it is possible to use a polyvinyl alcohol resin (a1-3) having an ionic functional group other than the sulfonic acid group and the carboxyl group.

As the ionic functional group other than the sulfonic acid group and the carboxyl group, the above-described acidic functional group and basic functional group can be suitably used, and among these, an acidic functional group is preferable.

In the above-described resin (a1-3), the sulfonic acid group and the carboxyl group are not contained, and a saponification degree thereof is preferably 60 to 100 mol %, more preferably in a range of 70 to 100 mol %, still more preferably in a range of 80 to 100 mol %, and particularly preferably in a range of 90 to 99.9 mol %.

A degree of polymerization of the polyvinyl alcohol resin (a1-3) having an ionic functional group other than the sulfonic acid group and the carboxyl group is preferably 100 to 4,000 and more preferably 100 to 3,000.

As a polymerization method for the above-described polyvinyl alcohol resin (a1-3) having an ionic functional group other than the sulfonic acid group and the carboxyl group, the polyvinyl alcohol resin (a1-3) having an ionic functional group other than the sulfonic acid group and the carboxyl group can be obtained by a known polymerization method itself, for example, a method of copolymerizing a compound having an ionic functional group other than the sulfonic acid group and the carboxyl group, and having a polymerizable unsaturated group with a fatty acid vinyl ester such as vinyl acetate, and further saponifying the obtained polymer.

A proportion of a polymerizable unsaturated monomer unit having an ionic functional group other than the sulfonic acid group and the carboxyl group is preferably 0.1% to 30% by mass, more preferably 0.2% to 10% by mass, and still more preferably 0.2% to 5% by mass with respect to the total mass of monomer units constituting the above-described polyvinyl alcohol resin (a1-3).

Regarding the synthesizing method and the like of the resin (a1-3), the method described for the resin (a1-1) can be suitably used.

[Carboxymethyl Celluloses (a2)]

The above-described carboxymethyl celluloses (a2) are compounds having a structure in which a part or all of hydroxyl groups in glucose residues constituting celluloses are substituted with a carboxymethyl ether group, and may be in a form of salts. As the salt of carboxymethyl cellulose, metal salts such as carboxymethyl cellulose sodium salt are exemplary examples.

A weight-average molecular weight of the above-described carboxymethyl celluloses is preferably 5,000 to 500,000 and more preferably 10,000 to 100,000.

In the present specification, the weight-average molecular weight can be measured by the measurement method of a molecular weight by gel permeation chromatography (GPC), which is described in “Method for measuring degree of polymerization” above.

A degree of etherification of the above-described carboxymethyl celluloses is preferably 0.5 to 1.5 and more preferably 0.6 to 1.2.

In the present specification, the degree of etherification is measured by an ashing measurement method. Specifically, 0.6 g of the carboxymethyl celluloses is dried at 105° C. for 4 hours. After the mass of the dried material is precisely weighed, the dried material is wrapped in filter paper and ashed in a magnetic crucible. The ashed material is transferred to a 500 mL beaker, 250 ml of water and 35 mL of a 0.05 mol/L sulfuric acid aqueous solution are added thereto, and the mixture is boiled for 30 minutes. After cooling, excess acid is reverse-titrated with a 0.1 mol/L potassium hydroxide aqueous solution. Phenolphthalein is used as an indicator. The degree of etherification is calculated by the following expression with the measurement result.

Degree of etherification=162×A/(10000−80A)

In the expression, A=(af−bf1)/Mass of dried material (g),
A: amount (mL) of 0.05 mol/L sulfuric acid aqueous solution consumed by bonding alkali in 1 g of the sample,
a: used amount (mL) of 0.05 mol/L sulfuric acid aqueous solution,
f: titer of 0.05 mol/L sulfuric acid aqueous solution
b: titration amount (mL) of 0.1 mol/L potassium hydroxide aqueous solution, and
f1: titer of 0.1 mol/L potassium hydroxide aqueous solution

The method for producing the above-described carboxymethyl celluloses is not particularly limited, and the carboxymethyl celluloses can be produced by a known production method itself. For example, the carboxymethyl celluloses can be produced by reacting cellulose with an alkali, adding an etherifying agent to the alkali-modified cellulose, and performing an etherification reaction.

### <Other Resins>

A resin other than the above-described resin (a) may be optionally blended to the dispersion resin (A).

For example, an acrylic resin other than the resin (a), a polyester resin, an epoxy resin, an alkyd resin, a urethane resin, a silicone resin, a polycarbonate resin, a chlorine-based resin, a fluorine-based resin, a polyvinyl acetal resin, composite resins thereof, and the like are exemplary examples. These resins can be used alone or in a combination of two or more.

Among these, it is preferable to use at least one polyvinylidene fluoride (PVDF).

In addition, these resins can be blended in the carbon nanotube dispersed liquid as a pigment dispersion resin or as an additive resin after pigment dispersion.

### <Carbon Nanotubes (B)>

As the above-described carbon nanotubes (B), it is possible to use single-walled carbon nanotubes or multi-walled carbon nanotubes alone, or to use a combination thereof. In particular, from the relationship of viscosity, conductivity, and cost, it is preferable to use single-walled carbon nanotube.

An average value of outer diameters of the above-described carbon nanotubes (B) is preferably 0.5 to 30 nm, more preferably 0.7 to 20 nm, and particularly preferably 1 to 10 nm.

In the present specification, the average value of outer diameters of the carbon nanotubes (B) is a value obtained by observing 100 arbitrarily extracted carbon nanotubes with a transmission electron microscope, measuring outer diameters thereof, and calculating the average value.

An average value of lengths of the above-described carbon nanotubes (B) is preferably 1 to 100 μm, more preferably 5 to 80 μm, and particularly preferably 10 to 60 μm.

In the present specification, the average value of lengths of the carbon nanotubes (B) is a value obtained by observing 100 arbitrarily extracted carbon nanotubes with a transmission electron microscope, measuring lengths thereof, and calculating the average value.

An average particle size (D50) of aggregates of primary particles of the carbon nanotubes (B) is preferably less than 7 μm, more preferably 5 μm or less, and particularly preferably less than 4 μm.

In the present specification, the average particle size (D50) is a value calculated by diluting the carbon nanotube dispersed liquid with water to measure concentration, stirring the mixture, and measuring volume-based particle size distribution by a laser diffraction scattering method using a particle size distribution measuring device (manufactured by Microtrac Retsch GmbH, product name: Microtrac MT3000).

From the relationship of viscosity and conductivity, a BET specific surface area of the above-described carbon nanotubes (B) is preferably in a range of 50 to 1,800 m²/g, more preferably in a range of 600 to 1,600 m²/g, and still more preferably in a range of 800 to 1,400 m²/g.

In the present specification, the BET specific surface area is a value obtained by a measurement method in accordance with “JIS Z8830 Determination of the Specific Surface Area of Powders (Solids) by Gas Adsorption-BET Method”.

Generally, since the single-walled carbon nanotubes have a large specific surface area and the multi-walled carbon nanotubes have a small specific surface area, the single-walled carbon nanotubes having a large specific surface area are suitable for electrode applications.

In addition, in a Raman spectrum of the above-described carbon nanotubes (B), in a case where the maximum peak intensity in a range of 1560 to 1600 cm⁻¹ is defined as G and the maximum peak intensity in a range of 1310 to 1350 cm⁻¹ is defined as D, a G/D ratio is usually 5 to 200, preferably 20 to 180, more preferably 40 to 150, and still more preferably 70 to 130.

Here, in a case where the G/D ratio is 5 or more, crystallinity is high and conductivity is excellent, and the upper limit thereof is, for example, approximately 200.

In the present specification, the Raman spectrum of the carbon nanotubes is a value obtained by installing the carbon nanotubes in a Raman microscope (XploRA, manufactured by HORIBA, Ltd.), and performing measurement using a laser wavelength of 532 nm. The G/D ratio is a value obtained by calculating a ratio of G/D as the G/D ratio of the carbon nanotubes, in a case where, among the obtained peaks in the spectrum, the maximum peak intensity in a range of 1560 to 1600 cm⁻¹ is defined as G and the maximum peak intensity in a range of 1310 to 1350 cm⁻¹ is defined as D.

The above-described carbon nanotubes (B) are preferably one kind of carbon nanotube.

<Conductive Pigment Other than Carbon Nanotubes (B)>

The carbon nanotube dispersed liquid according to the embodiment of the present invention may contain a conductive pigment other than the carbon nanotubes. Specifically, for example, conductive carbons (B-2) such as acetylene black, Ketjen black, furnace black, thermal black, graphene, and graphite are exemplary examples. These conductive carbons (B-2) can be used in combination of two or more kinds thereof.

From the relationship of viscosity and conductivity, an average primary particle size of the above-described conductive carbon (B-2) is preferably in a range of 10 to 80 nm and more preferably in a range of 20 to 50 nm.

Here, the above-described average primary particle size refers to an average size of primary particles, which is obtained by observing the pigment with an electron microscope, determining a projected area of each of 100 particles, determining a diameter assuming a circle equal to this area, and simply averaging the diameters of the 100 particles. In a case where the pigment is in an aggregated state, the calculation is carried out with primary particles constituting the aggregated particles.

From the relationship of viscosity and conductivity, a BET specific surface area of the above-described conductive carbon (B-2) is preferably in a range of 1 to 500 m²/g and more preferably in a range of 30 to 150 m²/g.

From the relationship of pigment dispersibility, the above-described conductive carbon (B-2) is preferably basic, and specifically, a pH thereof is preferably 7.5 or more, more preferably 8.0 to 12.0, and still more preferably 8.5 to 11.0.

In the present specification, the pH of the conductive carbon (B-2) can be measured by ASTM D1512.

In addition, from the viewpoint of conductivity, the above-described conductive carbon (B-2) is preferably in a state in which the primary particles form a chain structure, and a structure index is more preferably in a range of 1.5 to 4.0 and particularly in a range of 1.7 to 3.2.

It is possible to relatively easily observe the structure itself even in images taken with an electron microscope, but the structure index is a numerical value that quantifies the degree of structure. Generally, it is possible to define the structure index as the DBP oil absorption amount (ml/100 g) divided by the specific surface area (m²/g). In a case where the structure index is 1.5 or more, it is easy to obtain sufficient conductivity due to the developed structure. In addition, in a case where the structure index is 4.0 or less, the particle size is an appropriate size with respect to the DBP oil absorption amount and a conductive path is easily secured, so that it is possible to exhibit sufficient conductivity and the viscosity of the carbon nanotube dispersed liquid can be easily adjusted to an appropriate level.

### <Solvent>

The carbon nanotube dispersed liquid according to the embodiment of the present invention contains water as a solvent, but may contain a solvent other than water (in particular, an aqueous solvent dissolved in water).

As the above-described aqueous solvent, for example, alcohols such as ethanol, propanol, butanol, methyl cellosolve, butyl cellosolve, and propylene glycol monomethyl ether, N-methyl-2-pyrrolidone, and the like are exemplary examples. These solvents can be used alone or in a combination of two or more together with water.

### <Other Additives>

In the carbon nanotube dispersed liquid according to the embodiment of the present invention, a component other than the component (A), component (B), and water described above (also denoted as other additives) may be blended. As the other additives, for example, a neutralizing agent, a pH adjuster, a pigment dispersant, an antifoaming agent, an antiseptic agent, a rust inhibitor, a plasticizer, a binding agent (a binder), and the like are exemplary examples.

An initial viscosity of the carbon nanotube dispersed liquid is preferably less than 15 Pa·s, more preferably 13 Pa·s or less, and particularly preferably less than 12 Pa·s.

In the present specification, the initial viscosity of the carbon nanotube dispersed liquid is a value of the carbon nanotube dispersed liquid, which is measured at a shear speed of 5.0 sec⁻¹ using a cone and plate-type viscometer (manufactured by Thermo Fisher Scientific, product name: Mars2, diameter: 35 mm, 2° inclined cone and plate). The carbon nanotube dispersed liquid used for the measurement is used within 60 minutes immediately after the carbon nanotube dispersed liquid is produced.

A volume resistivity of the electrode layer for a lithium ion battery, formed of the carbon nanotube dispersed liquid, is preferably less than 12 Ω·cm, more preferably less than 10 Ω·cm, and particularly preferably 9 Ω·cm or less.

In the present specification, the volume resistivity of the electrode layer for a lithium ion battery is a value obtained by a method in which, after measuring a film thickness of the electrode layer, using an ASP probe (product name “MCP-TP03P”, manufactured by Mitsubishi Chemical Analytec Co., Ltd.), a resistance value is measured using a resistivity meter (product name “Loresta-GP MCP-T610”, manufactured by Mitsubishi Chemical Analytec Co., Ltd.) and a resistivity correction factor (RCF) of 4.532 and the film thickness are multiplied by the obtained resistance value to calculate the volume resistivity.

### <<Electrode for Lithium Ion Battery>>

The electrode for a lithium ion battery according to the embodiment of the present invention is obtained by coating a metal current collector with the carbon nanotube dispersed liquid according to the embodiment of the present invention to form an electrode layer for a lithium ion battery.

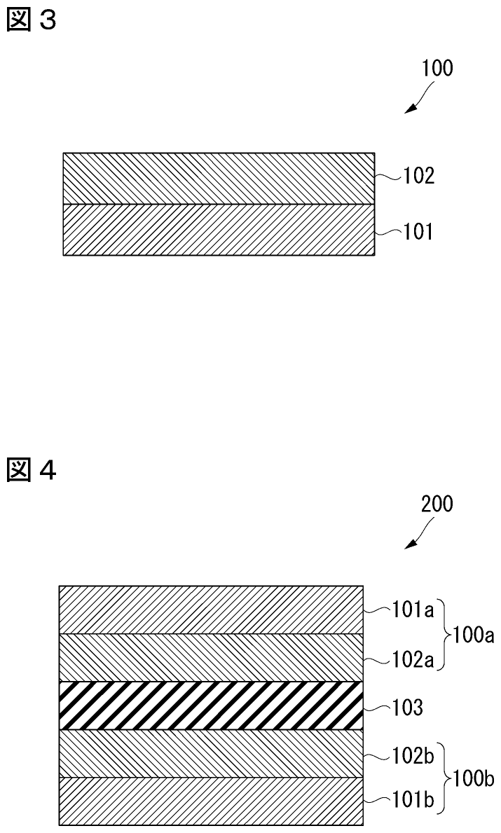

FIG. 3 is a cross-sectional view representing an example of the electrode for a lithium ion battery, having the electrode layer for a lithium ion battery. In FIG. 3, a metal current collector 101 is coated with the carbon nanotube dispersed liquid according to the embodiment of the present invention to form an electrode layer 102 for a lithium ion battery, thereby forming an electrode 100 for a lithium ion battery.

### <<Lithium Ion Battery>>

The lithium ion battery according to the embodiment of the present invention has the electrode layer for a lithium ion battery according to the embodiment of the present invention, on only a positive electrode, on only a negative electrode, or on both a positive electrode and a negative electrode.

FIG. 4 is a cross-sectional view representing an example of a lithium ion battery. In FIG. 4, the lithium ion battery is formed in a state in which a metal current collector (negative electrode) 101b, an electrode layer for a lithium ion battery (negative electrode) 102b, a separator 103, an electrode layer for a lithium ion battery (positive electrode) 102a, and a metal current collector (positive electrode) 101a are laminated in this order. The metal current collector (negative electrode) 101b and the electrode layer for a lithium ion battery (negative electrode) 102b constitute a negative electrode for a lithium ion battery 100b, and the metal current collector (positive electrode) 101a and the electrode layer for a lithium ion battery (positive electrode) 102a constitute a positive electrode for a lithium ion battery 100a. At least one of the electrode layer for a lithium ion battery (negative electrode) 102b or the electrode layer for a lithium ion battery (positive electrode) 102a may be formed of the carbon nanotube dispersed liquid according to the embodiment of the present invention, and the other thereof may be formed of the carbon nanotube dispersed liquid according to the embodiment of the present invention. An electrolyte (not shown) is held in the separator 103.

### <<Production Method of Carbon Nanotube Dispersed Liquid>>

With respect to the total mass of the carbon nanotube dispersed liquid, a solid content in the carbon nanotube dispersed liquid which is the first aspect of the present invention (also simply referred to as “carbon nanotube dispersed liquid”) is usually preferably less than 50% by mass, more preferably 10% by mass or less, and particularly preferably 5% by mass or less. The carbon nanotube dispersed liquid which is the first aspect of the present invention does not contain an electrode active material, and the carbon nanotube dispersed liquid for lithium ion battery electrodes, which is a second aspect of the present invention described later, contains an electrode active material.

With respect to the total mass of solid contents of the carbon nanotube dispersed liquid, the total amount of solid contents of the dispersion resin (A) in the solid contents of the carbon nanotube dispersed liquid according to the embodiment of the present invention is usually preferably 70% by mass or less, more preferably 60% by mass or less, and still more preferably 50% by mass or less, which is suitable from the viewpoint of viscosity, pigment dispersibility, dispersion stability, production efficiency, and the like during pigment dispersion.

With respect to the total mass of the carbon nanotube dispersed liquid, the content of the dispersion resin (A) in the carbon nanotube dispersed liquid according to the embodiment of the present invention is usually preferably 0.2% by mass or more and 10% by mass or less, more preferably 0.3% by mass or more and 5% by mass or less, and particularly preferably 0.5% by mass or more and 3% by mass or less.

With respect to the total mass of solid contents of the carbon nanotube dispersed liquid, a solid content of the carbon nanotubes (B) in the solid contents of the carbon nanotube dispersed liquid according to the embodiment of the present invention is usually preferably 30% by mass or more and less than 85% by mass, more preferably 40% by mass or more and less than 80% by mass, and still more preferably 50% by mass or more and less than 75% by mass, which is suitable from the viewpoint of battery performance.

With respect to the total mass of the carbon nanotube dispersed liquid, the content of the carbon nanotubes (B) in the carbon nanotube dispersed liquid according to the embodiment of the present invention is usually preferably 0.2% by mass or more and 5% by mass or less, more preferably 0.3% by mass or more and 3% by mass or less, and particularly preferably 0.5% by mass or more and 1.5% by mass or less.

In addition, with respect to the total mass of the carbon nanotube dispersed liquid, a content of the solvent in the carbon nanotube dispersed liquid according to the embodiment of the present invention is usually preferably 50% by mass or more and less than 100% by mass, more preferably 70% by mass or more and less than 99% by mass, and still more preferably 80% by mass or more and less than 98.5% by mass, which is suitable from the viewpoint of drying efficiency and paste viscosity.

The total content of the components contained in the carbon nanotube dispersed liquid according to the embodiment of the present invention does not exceed 100% by mass with respect to the total mass of the carbon nanotube dispersed liquid.

The carbon nanotube dispersed liquid according to the embodiment of the present invention can be prepared by mixing and dispersing each of the components described above using, for example, a known disperser in the related art, such as Scandix, paint shaker, sand mill, ball mill, pebble mill, LMZ mill, DCP pearl mill, planetary ball mill, homogenizer, twin-shaft kneading machine, and thin-film swirl-type high-speed mixer.

Specifically, it is preferable to produce the carbon nanotube dispersed liquid according to the embodiment of the present invention by mixing the dispersion resin (A), the carbon nanotubes (B), and water using a disperser (Clare Mix CLM-2.2S manufactured by M Technique Co., Ltd.) at a speed of 14,000 rpm to be uniform as a whole; performing dispersion until a dispersed particle size (D50) is 90 μm or less; performing dispersion for 12 paths at 60 MPa using a high-pressure homogenizer (Nano Vater manufactured by YOSHIDA KIKAI CO., LTD.), and then performing dispersion at specific dispersion conditions (number of paths).

The above-described number of paths is preferably more than 5 and less than 70, more preferably 7.5 or more and 50 or less, and particularly preferably 8 or more and 45 or less.

The number of paths is a unit indicating the number of times of theoretical processing, and is obtained from the following calculation expression.

Processing time required for one path (h)=Amount of paste liquid (L)÷Processing speed of disperser (L/h)

Number of paths (number of times of theoretical processing)=Processing time (h)÷Processing time required for one path (h)

As will be described later, the carbon nanotube dispersed liquid according to the embodiment of the present invention can be mixed with an electrode active material to manufacture an electrode layer for lithium ion battery electrodes.

In addition, in the present invention, it is found that information on a degree of dispersibility of the carbon nanotube dispersed liquid is obtained from a value of absorbance at a wavelength (268 nm). The absorbance (wavelength: 268 nm) of the carbon nanotube dispersed liquid is preferably 1.3 or more, more preferably 1.3 to 2.0, and particularly preferably 1.3 to 1.8.

In a case where the absorbance is 1.3 or more, the dispersibility is in a state of being appropriately advanced, and in a case of being 2.0 or less, it is easy to prevent the dispersibility from occurring in a state of excessive dispersion.

In the present specification, the absorbance of the carbon nanotube dispersed liquid is a value obtained by measuring an absorbance of a sample at the wavelength (268 nm) with U-1900 (product name, spectrophotometer, manufactured by Hitachi High-Technologies Corporation), in which the sample is prepared by diluting the carbon nanotube dispersed liquid with deionized water at a CNT concentration of 0.001% by mass, stirred to be uniform, and filled in a cell.

### <Impedance Spectrum>

The carbon nanotube dispersed liquid which is the first aspect of the present invention is characterized in that, in a Bode plot obtained by an impedance measurement, in which reactance is plotted on a vertical axis and frequency is plotted on a horizontal axis, the minimal value of reactance exists in a frequency range of 170 to 600 kHz. The minimal value of the reactance is preferably in a frequency range of 180 to 600 kHz and more preferably in a frequency range of 200 to 400 kHz.

In the present invention, the reactance means an imaginary part of complex impedance.

In the present specification, with regard to the Bode plot, using a two-pole electrode with an inter-electrode distance of 9 mm and a size of 100 mm², which is obtained by facing 0.3 mm-thick copper plates with gold-plated surfaces, 20 ml of a cylindrical container is filled with 15 ml of the carbon nanotube dispersed liquid, and the electrode is inserted thereto such that the electrode is completely embedded in the paste. Subsequently, a sinusoidal AC voltage with a peak-to-peak voltage of 0.1 V is applied to the carbon nanotube dispersed liquid at 25° C. using an impedance analyzer (manufactured by Keysight Technologies, product name “4294A”), and the complex impedance and phase difference are measured at 500 points while the frequency is swept between 100 Hz and 100 MHz. From the obtained data, the Bode plot is obtained by plotting reactance on the vertical axis and frequency on the horizontal axis.

A magnification (ratio) of the minimal value of the reactance to the reactance at a frequency of 1 kHz, which is represented by the following expression, is preferably more than 1.5 and 5.0 or less, more preferably 1.6 or more and 4.0 or less, and particularly preferably 1.7 or more and 3.5 or less.

Magnification (ratio) of minimal value of reactance to reactance at frequency of 1 KHz=[Minimal value of reactance]÷[Reactance at frequency of 1 kHz]

In the Bode plot, there may be minimal values of the reactance at two or more points. In particular, this tendency is remarkable in a case where two or more types of the carbon nanotubes (B) are used in combination, in a case where the carbon nanotubes (B) are used together with another conductive carbon, in a case where the dispersion time of the carbon nanotube dispersed liquid is extremely short, or the like. In addition, depending on the type of carbon nanotube (B) to be used, there may be minimal values of the reactance at two or more points. In a case where there are minimal values of the reactance at two or more points, at least one of the minimal values may be in a frequency range of 170 to 600 kHz.

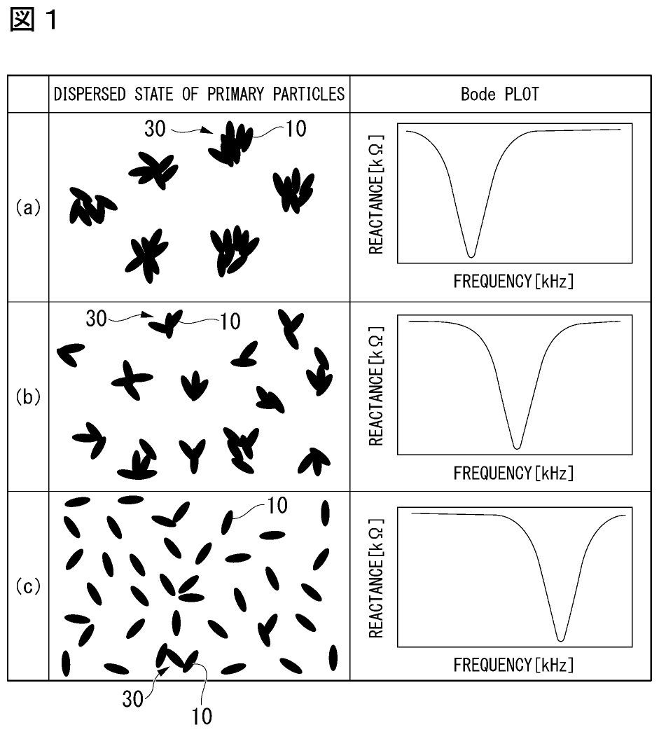

The carbon nanotubes (B) form a structure in the carbon nanotube dispersed liquid, and the minimal value of the reactance in the Bode plot moves according to a degree of structure growth of the carbon nanotubes (B), that is, with the size of the aggregates of the primary particles of the carbon nanotubes (B). For example, as shown in FIG. 1, as interaction of primary particles 10 is stronger and the degree of structure growth is higher, that is, aggregates of the primary particles of the carbon nanotubes (B) are larger, the minimal value of the reactance in the Bode plot tends to move to lower frequency region.

FIG. 1(a) is a Bode plot in a case where the degree of structure growth is high, FIG. 1(b) is a Bode plot in a case where the degree of structure growth is medium, and FIG. 1(c) is a Bode plot in a case where the degree of structure growth is low.

In the Bode plot, in a case where the minimal value of the reactance exists in a frequency range of 170 to 600 kHz, it means that the structure of the carbon nanotubes (B) is growing appropriately, that is, the primary particles of the carbon nanotubes (B) are dispersed in the carbon nanotube dispersed liquid while appropriately maintaining the structure. Therefore, in a case where an electrode layer is formed of the carbon nanotube dispersed liquid according to the embodiment of the present invention, the primary particles of the carbon nanotubes (B) are dispersed in the electrode layer while appropriately maintaining the structure. Accordingly, conductive paths are formed efficiently, and it is possible to form an electrode with excellent conductivity. In addition, the viscosity of the carbon nanotube dispersed liquid also tends to be low.

The Bode plot is obtained, for example, by an impedance measurement as shown below.

### (Preparation of Measurement Cell)

A two-pole electrode with an inter-electrode distance of 9 mm is used in which 0.3 mm-thick copper plates with gold-plated surfaces face each other. The size of the electrode is 100 mm². A 20 ml cylindrical container is filled with 15 ml of the carbon nanotube dispersed liquid, and the electrode is inserted thereto such that the electrode is completely embedded in the paste.

### (Impedance Measurement)

A sinusoidal AC voltage with a peak-to-peak voltage of 0.1 V is applied to the carbon nanotube dispersed liquid at 25° C. using an impedance analyzer, and the complex impedance and phase difference are measured at 500 points while the frequency is swept between 100 Hz and 100 MHz. From the obtained data, the Bode plot is created by plotting reactance on the vertical axis and frequency on the horizontal axis.

In the Bode plot, the minimum value (X) of the reactance existing in the frequency range of 170 to 600 KHz is preferably 1.8 times or more a value (Y) of reactance at a frequency of 1 kHz, more preferably 2.0 times or more, still more preferably 2.0 to 3.5 times, and particularly preferably 2.3 to 3.2 times.

As described above, in the Bode plot, there may be minimal values of the reactance at two or more points. Even in a case where there are a plurality of minimal values in the range of 170 to 600 kHz, the calculation (X/Y) may be performed at the minimum value in the range of 170 to 600 KHz.

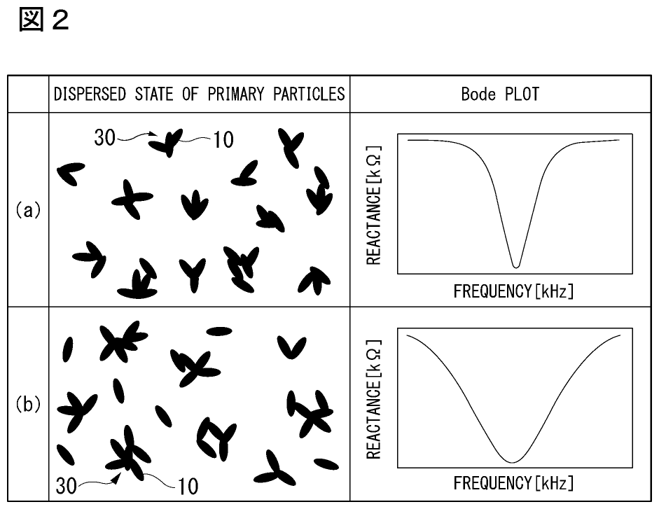

The ratio of the minimum value (X) with respect to the value (Y) described above is influenced by the particle size distribution of the aggregates of the primary particles of the carbon nanotubes (B). For example, as shown in FIG. 2(a), as the particle size of the aggregates of the primary particles of the carbon nanotubes (B) is more uniform, that is, is more lined up, the ratio of the minimum value (X) to the value (Y) described above tends to be larger. On the other hand, as shown in FIG. 2(b), as the particle size of the aggregates 30 of the primary particles 10 of the carbon nanotubes (B) is more non-uniform, the ratio of the minimum value (X) to the value (Y) described above tends to be smaller.

In a case where the above-described minimum value (X) is 1.8 times or more the above-described value (Y), it means that the particle size of the aggregates of the primary particles of the carbon nanotubes (B) in the carbon nanotube dispersed liquid is uniform. Therefore, in a case where an electrode layer is formed of the carbon nanotube dispersed liquid for lithium ion battery electrodes according to the embodiment of the present invention, which contains an electrode active material, the primary particles of the carbon nanotubes (B) are dispersed more uniformly in the electrode layer. Accordingly, conductive paths are formed more efficiently, and it is possible to form an electrode layer with more excellent conductivity.

### <<Carbon Nanotube Dispersed Liquid for Lithium Ion Battery Electrodes>>

As a second aspect of the present invention, there is provided a carbon nanotube dispersed liquid for lithium ion battery electrodes, which is obtained by blending an electrode active material (also simply referred to as “active material”) described later in the above-described carbon nanotube dispersed liquid, (also simply referred to as “carbon nanotube dispersed liquid for lithium ion battery electrodes”).

In the present invention, “coating film obtained by applying the carbon nanotube dispersed liquid” may be referred to as “electrode layer”.

### <Electrode Active Material>

As the electrode active material, a known material itself can be suitably used.

For example, as a positive electrode active material, lithium composite oxides such as lithium nickelate (LiNiO₂), lithium manganate (LiMn₂O₄), lithium cobaltate (LiCoO₂), LiNi_{1/3}Co_{1/3}Mn_{1/3}O₂, and the like are exemplary examples. These electrode active materials can be used alone or in a combination of two or more. In addition, as a negative electrode active material, for example, Li-based compounds, Sn-based compounds, Si-based compounds, graphite (natural graphite and artificial graphite), low crystalline carbon (hard carbon and soft carbon), and the like are exemplary examples. These electrode active materials can be used alone or in a combination of two or more.

With respect to the total mass of the carbon nanotube dispersed liquid for lithium ion battery electrodes, a solid content in the carbon nanotube dispersed liquid for lithium ion battery electrodes according to the embodiment of the present invention is usually preferably 70% by mass or more and less than 100% by mass, more preferably 80% by mass or more and less than 99% by mass, and particularly preferably 90% by mass or more and less than 98% by mass.

With respect to the total mass of solid contents of the carbon nanotube dispersed liquid for lithium ion battery electrodes, a solid content of the electrode active material in the solid contents of the carbon nanotube dispersed liquid for lithium ion battery electrodes according to the embodiment of the present invention, which contains the electrode active material, is usually 90% by mass or more and less than 100% by mass, preferably 95% by mass or more and less than 100% by mass and more preferably 98% by mass or more and less than 100% by mass, which is suitable from the viewpoint of battery capacity, battery resistance, and the like.

With respect to the total mass of the carbon nanotube dispersed liquid for lithium ion battery electrodes, the content of the electrode active material in the carbon nanotube dispersed liquid for lithium ion battery electrodes according to the embodiment of the present invention is usually preferably 30% by mass or more and less than 100% by mass, more preferably 40% by mass or more and less than 99% by mass, and particularly preferably 50% by mass or more and less than 98% by mass.

### <<Production Method of Carbon Nanotube Dispersed Liquid for Lithium Ion Battery Electrodes>>

The carbon nanotube dispersed liquid for lithium ion battery electrodes according to the embodiment of the present invention can be obtained by first preparing the carbon nanotube dispersed liquid which is the first aspect of the present invention, containing the component (A), component (B), and water described above, and blending the electrode active material in the carbon nanotube dispersed liquid.

In addition, the carbon nanotube dispersed liquid for lithium ion battery electrodes according to the embodiment of the present invention may be prepared by simultaneously mixing the component (A), component (B), and water described above with the electrode active material.

With respect to the total mass of the solid content of the carbon nanotube dispersed liquid for lithium ion battery electrodes, a solid content of the dispersion resin (A) in the solid content of the carbon nanotube dispersed liquid for lithium ion battery electrodes according to the embodiment of the present invention, which contains the electrode active material, is usually 0.001% to 20% by mass, preferably 0.005% to 10% by mass, which is suitable from the viewpoint of battery performance, paste viscosity, and the like.

With respect to the total mass of the solid content of the carbon nanotube dispersed liquid for lithium ion battery electrodes, a solid content of the carbon nanotubes (B) in the solid content of the carbon nanotube dispersed liquid for lithium ion battery electrodes according to the embodiment of the present invention, which contains the electrode active material, is usually 0.01% to 30% by mass, preferably 0.05% to 20% by mass and more preferably 0.1% to 15% by mass, which is suitable from the viewpoint of battery performance.

In addition, with respect to the total mass of the carbon nanotube dispersed liquid for lithium ion battery electrodes, a content of the solvent in the solid content of the carbon nanotube dispersed liquid for lithium ion battery electrodes according to the embodiment of the present invention, which contains the electrode active material, is usually 0.1% to 60% by mass, preferably 0.5% to 50% by mass and more preferably 1% to 45% by mass, which is suitable from the viewpoint of electrode drying efficiency, paste viscosity, and the like.

### <<Manufacturing Method of Electrode for Lithium Ion Battery>>

As described above, the electrode for a lithium ion secondary battery can be manufactured by coating a surface of an electrode core material (metal current collector) with the carbon nanotube dispersed liquid for lithium ion battery electrodes, which contains the electrode active material, and drying the dispersed liquid.

In addition, as applications of the carbon nanotube dispersed liquid for lithium ion battery electrodes according to the embodiment of the present invention, it can also be used as a primer layer between the electrode core material and the electrode layer.

As the applying method of the carbon nanotube dispersed liquid for lithium ion battery electrodes, which contains the electrode active material, the applying method can be performed by a known method using a die coater or the like itself. An applying amount of the carbon nanotube dispersed liquid for lithium ion battery electrodes, which contains the electrode active material, is not particularly limited, and for example, the applying amount can be set so that a thickness of the electrode layer after drying is in a range of 0.001 to 0.5 mm (preferably in a range of 0.01 to 0.4 mm). The temperature of the drying step can be appropriately set, for example, in a range of 80° C. to 200° C., preferably 100° C. to 180° C. The time for the drying step can be appropriately set, for example, in a range of 5 to 1200 seconds, preferably 5 to 120 seconds.

### <<Manufacturing Method of Lithium Ion Battery>>

The lithium ion battery according to the embodiment of the present invention can be manufactured by forming a laminate in which the electrode for a lithium ion secondary battery according to the present invention is used for only a positive electrode, only a negative electrode, or both the positive electrode and the negative electrode, and a separator is laminated between the positive electrode and the negative electrode, and then injecting an electrolyte into the obtained laminate.

Hereinafter, the present invention will be more specifically described with reference to Examples, but the present invention is not limited to these specific embodiments.

### EXAMPLES

Hereinafter, the present invention will be described in more detail with reference to Production Examples, Examples, and Comparative Examples, but the present invention is not limited to these examples. In each example, “part” indicates part by mass, and “%” indicates % by mass.

### <Production of Dispersion Resin>

### Production Example 1 Production of Sulfonic Acid-Modified Polyvinyl Alcohol Resin

A copolymerization reaction was performed at a temperature of approximately 60° C. with 92 parts by mass of vinyl acetate and 8.0 parts by mass of sodium allyl sulfonate as polymerizable monomers, methanol as a solvent, and azobisisobutyronitrile as a polymerization initiator in a reaction container equipped with a thermometer, a reflux cooling tube, a nitrogen gas inlet tube, and a stirrer; and unreacted monomers were removed under reduced pressure to obtain a resin solution. Next, a methanol solution of sodium hydroxide was added thereto to perform a saponification reaction, washing was carried out thoroughly, and drying was carried out in a hot air dryer. Finally, a polyvinyl alcohol resin No. 1 (PVA 1) having a degree of polymerization of 300, a saponification degree of 90 mol %, and containing a sulfonic acid group-containing monomer unit (an ionic functional group-containing monomer unit) was obtained.

### Production Example 2 Production of Sulfonic Acid-Modified Polyvinyl Alcohol Resin

A copolymerization reaction was performed at a temperature of approximately 60° C. with 92 parts by mass of vinyl acetate and 2.0 parts by mass of sodium allyl sulfonate as polymerizable monomers, methanol as a solvent, and azobisisobutyronitrile as a polymerization initiator in a reaction container equipped with a thermometer, a reflux cooling tube, a nitrogen gas inlet tube, and a stirrer; and unreacted monomers were removed under reduced pressure to obtain a resin solution. Next, a methanol solution of sodium hydroxide was added thereto to perform a saponification reaction, washing was carried out thoroughly, and drying was carried out in a hot air dryer. Finally, a polyvinyl alcohol resin No. 2 (PVA 2) having a degree of polymerization of 300, a saponification degree of 90 mol %, and containing a sulfonic acid group-containing monomer unit (an ionic functional group-containing monomer unit) was obtained.

### Production Example 3 Production of Carboxylic Acid-Modified Polyvinyl Alcohol Resin

A copolymerization reaction was performed at a temperature of approximately 60° C. with 92 parts by mass of vinyl acetate and 2.0 parts by mass of acrylic acid as polymerizable monomers, methanol as a solvent, and azobisisobutyronitrile as a polymerization initiator in a reaction container equipped with a thermometer, a reflux cooling tube, a nitrogen gas inlet tube, and a stirrer; and unreacted monomers were removed under reduced pressure to obtain a resin solution. Next, a methanol solution of sodium hydroxide was added thereto to perform a saponification reaction, washing was carried out thoroughly, and drying was carried out in a hot air dryer. Finally, a polyvinyl alcohol resin No. 3 (PVA 3) having a degree of polymerization of 300, a saponification degree of 90 mol %, and containing a carboxyl group-containing monomer unit (an ionic functional group-containing monomer unit) was obtained.

### Production Example 3 Production of Polyvinyl Alcohol Resin not Containing Polar Functional Group

A copolymerization reaction was performed at a temperature of approximately 60° C. with vinyl acetate as a polymerizable monomer, methanol as a solvent, and azobisisobutyronitrile as a polymerization initiator in a reaction container equipped with a thermometer, a reflux cooling tube, a nitrogen gas inlet tube, and a stirrer; and unreacted monomers were removed under reduced pressure to obtain a resin solution. Next, a methanol solution of sodium hydroxide was added thereto to perform a saponification reaction, washing was carried out thoroughly, and drying was carried out in a hot air dryer. Finally, a polyvinyl alcohol resin No. 4 (PVA 4) having a degree of polymerization of 500, a saponification degree of 88 mol %, and not containing a polar functional group was obtained.

### <<Production of Carbon Nanotube Dispersed Liquid>>

### Examples 1 to 12 and Comparative Examples 1 to 3

The dispersion resin (A), the carbon nanotubes (B), and water were mixed with the types and amounts described in Table 1 using a disperser (Clare Mix CLM-2.2S manufactured by M Technique Co., Ltd.) at a speed of 14,000 rpm to be uniform as a whole, and dispersion was performed until a dispersed particle size (D50) was 90 μm or less. Subsequently, after performing dispersion for 12 paths at 60 MPa using a high-pressure homogenizer (Nano Vater manufactured by YOSHIDA KIKAI CO., LTD.), dispersion was further performed under dispersion conditions (number of paths) described in Table 1 to obtain carbon nanotube dispersed liquids (X-1) to (X-15). The resin blending amount in Table 1 is the value of solid content.

The number of paths is a unit indicating the number of times of theoretical processing, and is obtained from the following calculation expression.

Processing time required for one path (h)=Amount of paste liquid (L)÷Processing speed of disperser (L/h)

Number of paths (number of times of theoretical processing)=Processing time (h)÷Processing time required for one path (h)

TABLE 1

| Examples and | | | Example | | | | | | | |
|---|---|---|---|---|---|---|---|---|---|---|
| Comparative Examples | | | 1 | 2 | 3 | 4 | 5 | 6 | 7 | 8 |
| Name of carbon nanotube | | | X-1 | X-2 | X-3 | X-4 | X-5 | X-6 | X-7 | X-8 |
| dispersed liquid | | | | | | | | | | |
| Dispersion | PVA1 | | | | | | | | | |
| resin | PVA2 | | | | | | | | | |
| | PVA3 | | | | | | | | | |
| | PVA4 | | | | | | | | | |
| | CMC1 | | 0.8 | 0.8 | 1.2 | 1.2 | 1.2 | 1.6 | 1.2 | 2.1 |
| | CMC2 | | | | | | | | | |
| | Methyl | | | | | | | | | |
| | cellulose | | | | | | | | | |
| CNT | SWCNT1 | | 0.8 | 0.8 | 0.8 | 0.8 | 0.8 | 0.8 | | 0.4 |
| | SWCNT2 | | | | | | | | 0.8 | |
| | MWCNT | | | | | | | | | 5 |
| Water | | | 98.4 | 98.4 | 98 | 98 | 98 | 97.6 | 98 | 92.5 |
| Total | | | 100 | 100 | 100 | 100 | 100 | 100 | 100 | 100 |
| Number of paths | | | 19 | 28 | 10 | 20 | 39 | 25 | 20 | 20 |
| Impedance | Reactance | | −304 | −362 | −175 | −193 | −252 | −141 | −350 | −219 |
| | Frequency | | 172 | 237 | 274 | 251 | 584 | 410 | 240 | 338 |
| | Magnification | | 2.7 | 2.6 | 1.8 | 2.3 | 3.2 | 2.5 | 2.2 | 1.8 |
| | at 1 kHz | | | | | | | | | |
| Absorbance | | | 1.5 | 1.4 | 1.4 | 1.6 | 1.7 | 1.6 | 1.5 | 1.3 |
| Evaluation | Particle | μm | 3.77 | 3.49 | 4.83 | 3.55 | 3.20 | 3.50 | 3.40 | 2.90 |
| | size | Evaluation | A | A | B | A | A | A | A | A |
| | Viscosity | Pa · s | 10.9 | 9.7 | 11.5 | 10.8 | 11.0 | 12.5 | 6.2 | 5.0 |
| | | Evaluation | A | A | A | A | A | B | A | A |
| | Resistance | Ω · cm | 6.6 | 6.6 | 7.0 | 5.6 | 6.1 | 7.5 | 7.0 | 9.8 |
| | value | Evaluation | A | A | A | A | A | A | A | A |

| Examples and | | | Example | | | | Comparative Example | | |
|---|---|---|---|---|---|---|---|---|---|
| Comparative Examples | | | 9 | 10 | 11 | 12 | 1 | 2 | 3 |
| Name of carbon nanotube | | | X-9 | X-10 | X-11 | X-12 | X-13 | X-14 | X-15 |
| dispersed liquid | | | | | | | | | |
| Dispersion | PVA1 | | | 1.2 | | | | | |
| resin | PVA2 | | | | 1.2 | | | | |
| | PVA3 | | | | | 1.2 | | | |
| | PVA4 | | | | | | | 1.2 | 1.2 |
| | CMC1 | | | | | | | | |
| | CMC2 | | 1.2 | | | | | | |
| | Methyl | | | | | | 1.2 | | |
| | cellulose | | | | | | | | |
| CNT | SWCNT1 | | 0.8 | 0.8 | 0.8 | 0.8 | 0.8 | 0.8 | 0.8 |
| | SWCNT2 | | | | | | | | |
| | MWCNT | | | | | | | | |
| Water | | | 98 | 98 | 98 | 98 | 98 | 98 | 98 |
| Total | | | 100 | 100 | 100 | 100 | 100 | 100 | 100 |
| Number of paths | | | 9 | 20 | 20 | 20 | 5 | 20 | 70 |
| Impedance | Reactance | | −171 | −231 | −252 | −245 | −170 | −122 | −216 |
| | Frequency | | 450 | 190 | 250 | 200 | 317 | 100 | 410.0 |
| | Magnification | | 2.4 | 1.8 | 2.4 | 1.8 | 1.5 | 1.3 | 1.8 |
| | at 1 kHz | | | | | | | | |
| Absorbance | | | 1.4 | 1.6 | 1.6 | 1.5 | 1.2 | 1.1 | 1.3 |
| Evaluation | Particle | μm | 4.00 | 3.70 | 3.49 | 3.60 | 7.61 | 8.00 | 2.90 |
| | size | Evaluation | B | A | A | A | C | C | A |
| | Viscosity | Pa · s | 5.5 | 5.5 | 5.5 | 5.5 | 11.5 | 100.0 | 25.0 |
| | | Evaluation | A | A | A | A | A | C | C |
| | Resistance | Ω · cm | 5.7 | 8.0 | 6.6 | 8.0 | 13.0 | 14.0 | 7.0 |
| | value | Evaluation | A | A | A | A | C | C | A |

The symbol of each raw material in Table 1 is as follows.

### [Dispersion Resin]

CMC1: sodium salt of carboxymethyl cellulose, weight-average molecular weight: 56,000, degree of etherification: 0.7
CMC2: sodium salt of carboxymethyl cellulose, weight-average molecular weight: 18,000, degree of etherification: 0.7
Methyl cellulose: weight-average molecular weight: 30,000, degree of etherification: 1.5

### [Carbon Nanotube]

SWCNT1: single-walled carbon nanotube, specific surface area: 1100 m²/g, outer diameter: 1.56 nm, G/D ratio: 100
SWCNT2: single-walled carbon nanotube, specific surface area: 1070 m²/g, outer diameter: 1.3 nm, G/D ratio: 87
MWCNT: multi-walled carbon nanotube, specific surface area: 170 m²/g, outer diameter: 9 nm, G/D ratio: 0.96

The G/D ratio of the carbon nanotubes, the impedance of the carbon nanotube dispersed liquid, and the absorbance of the carbon nanotube dispersed liquid were measured by the following methods.

### [Measurement of G/D Ratio of Carbon Nanotubes]

The Raman spectrum of the carbon nanotubes was obtained by installing the carbon nanotubes in a Raman microscope (XploRA, manufactured by HORIBA, Ltd.), and performing measurement using a laser wavelength of 532 nm. A ratio of G/D in a case where, among the obtained peaks in the spectrum, the maximum peak intensity in a range of 1560 to 1600 cm⁻¹ was defined as G and the maximum peak intensity in a range of 1310 to 1350 cm⁻¹ was defined as D was used as the G/D ratio of the carbon nanotubes.

### [Impedance Measurement of Carbon Nanotube Dispersed Liquid]

### (Preparation of Measurement Cell)

A two-pole electrode with an inter-electrode distance of 9 mm was used in which 0.3 mm-thick copper plates with gold-plated surfaces faced each other. The size of the electrode was 100 mm². A 20 ml cylindrical container was filled with 15 ml of each carbon nanotube dispersed liquid obtained in Examples and Comparative Examples, and the electrode was inserted thereto such that the electrode was completely embedded in the paste.

### (Impedance Measurement)

A sinusoidal AC voltage with a peak-to-peak voltage of 0.1 V was applied to each carbon nanotube dispersed liquid obtained in Examples and Comparative Examples at 25° C. using an impedance analyzer (manufactured by Keysight Technologies, product name “4294A”), and the complex impedance and phase difference were measured at 500 points while the frequency is swept between 100 Hz and 100 MHz. From the obtained data, a Bode plot was created by plotting reactance on the vertical axis and frequency on the horizontal axis.

Next, minimal values (in Examples and Comparative Examples, all the minimal values were 1 point) of the reactance were confirmed, and a magnification with reactance at a frequency of 1 kHz was calculated by the following expression.

Magnification at 1 KHz=[Minimal value of reactance]÷[Reactance at frequency of 1 kHz]

### [Measurement of Absorbance of Carbon Nanotube Dispersed Liquid]

The carbon nanotube dispersed liquid was diluted with deionized water to adjust a CNT concentration to 0.001% by mass, and the mixture was stirred to be uniform. Next, the sample was filled in a cell, and using U-1900 (product name, spectrophotometer, manufactured by Hitachi High-Technologies Corporation), an absorbance at a wavelength (268 nm) was measured.

### <Evaluation Test>

The carbon nanotube dispersed liquid produced by the above-described production method was subjected to an evaluation test by the following evaluation method. The results of the evaluation test are shown in Table 1 above. In the present invention, it is important for the carbon nanotube dispersed liquid to have excellent performance in all items in the evaluation test, and in a case where any one thereof is evaluated as rejected, the carbon nanotube dispersed liquid is rejected.

### [Average Particle Size (D50)]

An average particle size (D50) was by diluting the obtained carbon nanotube dispersed liquid with water to measure concentration, stirring the mixture, and measuring volume-based particle size distribution by a laser diffraction scattering method using a particle size distribution measuring device (manufactured by Microtrac Retsch GmbH, product name: Microtrac MT3000). Evaluation was carried out according to the following standard. Basically, it is preferable that the average particle size (D50) is small, and A and B are acceptable and C is unacceptable.
A (very good): average particle size (D50) was less than 4 μm.
B (good): average particle size (D50) was 4 μm or more and less than 7 μm.
C (poor): average particle size (D50) was 7 μm or more.

### [Initial Viscosity (Dispersibility)]

Using a cone and plate-type viscometer (manufactured by Thermo Fisher Scientific, product name: Mars2, diameter: 35 mm, 2° inclined cone and plate), an initial viscosity of the obtained carbon nanotube dispersed liquid was measured at a shear speed of 5.0 sec⁻¹. It is preferable that the viscosity is lower at the same concentration, and A and B are acceptable and C is unacceptable. The carbon nanotube dispersed liquid used for the measurement was used within 60 minutes immediately after the carbon nanotube dispersed liquid was produced.
A (very good): initial viscosity was less than 12 Pa·s.
B (good): initial viscosity was 12 Pa·s or more and less than 15 Pa·s.
C (poor): initial viscosity was 15 Pa·s or more.

### <<Production of Carbon Nanotube Dispersed Liquid for Lithium Ion Battery Electrodes, Containing Electrode Active Material, and Manufacturing of Electrode Layer>>

### Examples Y1 to Y12 and Comparative Examples Y1 to Y3 (CNT Dispersed Liquid)

### Examples Z1 to Z12 and Comparative Examples Z1 to Z3 (Electrode Layer)

59.1 parts of an electrode active material [(lithium iron phosphate particles with an olivine structure represented by compositional formula LiFePO₄ (average particle size: 1.3 μm, BET specific surface area: 12.0 m²/g)] and 1.8 parts of SBR (styrene-butadiene rubber, manufactured by JSR Corporation, product name: TRD102A, solid content: 48.5 wt %) were mixed using a mixer, and 10 parts of each carbon nanotube dispersed liquid obtained in Examples 1 to 12 and Comparative Examples 1 to 3 and 50 parts of water were mixed therewith to produce a carbon nanotube dispersed liquid for lithium ion battery electrodes, which contained the electrode active material, (Examples Y1 to Y12 and Comparative Examples Y1 to Y3).

Subsequently, the carbon nanotube dispersed liquid for lithium ion battery electrodes was applied onto an OHP film having a thickness of 100 μm (PPC/PET film for laser, manufactured by FUJIFILM Business Innovation Corp.) using an applicator, and dried at 80° C. to obtain an electrode layer for a lithium ion battery (positive electrode layer) (Examples Z1 to Z12 and Comparative Examples Z1 to Z3).

### [Volume Resistivity]

After measuring a film thickness of the obtained electrode layer (Examples Z1 to Z12 and Comparative Examples Z1 to Z3), using an ASP probe (manufactured by Mitsubishi Chemical Analytec Co., Ltd., product name “MCP-TP03P”), a resistance value was measured using a resistivity meter (manufactured by Mitsubishi Chemical Analytec Co., Ltd., product name “Loresta-GP MCP-T610”) and a resistivity correction factor (RCF) of 4.532 and the film thickness of the coating film were multiplied by the obtained resistance value to calculate a volume resistivity. The volume resistivity was evaluated according to the following standard. It is preferable that the volume resistivity is low, and A and B are acceptable and C is unacceptable.
A (very good): volume resistivity was less than 10 Ω·cm.
B (good): volume resistivity was 10 2.cm or more and less than 12 Ω·cm.
C (poor): volume resistivity was 12 Ω·cm or more.

### INDUSTRIAL APPLICABILITY

According to the present invention, it is possible to provide a carbon nanotube dispersed liquid for lithium ion battery electrodes, which has a viscosity easily applied even in a case where a blending amount of a dispersion resin is relatively small.

### REFERENCE SIGNS LIST

10: Primary particle of carbon nanotube (B)
30: Aggregate of primary particles of carbon nanotube (B)
100: Electrode for lithium ion battery
100a: Positive electrode for lithium ion battery
100b: Negative electrode for lithium ion battery
101: Metal current collector
101a: Metal current collector (positive electrode)
101b: Metal current collector (negative electrode)
102: Electrode layer for lithium ion battery
102a: Electrode layer for lithium ion battery (positive electrode)
102b: Electrode layer for lithium ion battery (negative electrode)
103: Separator
200: Lithium ion battery

1. A carbon nanotube dispersed liquid, comprising:
a dispersion resin (A);
carbon nanotubes (B); and
water,
wherein the dispersion resin (A) contains a polar functional group-containing resin (a).

2. The carbon nanotube dispersed liquid according to claim 1,
wherein the polar functional group-containing resin (a) is at least one selected from the group consisting of an ionic polyvinyl alcohol resin (a1) and carboxymethyl celluloses (a2).

3. The carbon nanotube dispersed liquid according to claim 2,
wherein the ionic polyvinyl alcohol resin (a1) is at least one selected from the group consisting of a sulfonic acid-modified polyvinyl alcohol resin (a1-1) and a carboxylic acid-modified polyvinyl alcohol resin (a1-2).

4. The carbon nanotube dispersed liquid according to claim 3,
wherein the ionic polyvinyl alcohol resin (a1) is the sulfonic acid-modified polyvinyl alcohol resin (a1-1), and
a proportion of a monomer unit having a sulfonic acid group in the sulfonic acid-modified polyvinyl alcohol resin (a1-1) is 0.1% to 30% by mass.

5. The carbon nanotube dispersed liquid according to claim 2,
wherein a saponification degree of the ionic polyvinyl alcohol resin (a1) is 50 to 100 mol %.

6. The carbon nanotube dispersed liquid according to claim 1,
wherein a BET specific surface area of the carbon nanotubes (B) is 50 to 1,800 m²/g, and
in a Raman spectrum of the carbon nanotubes (B), in a case where a maximum peak intensity in a range of 1560 to 1600 cm⁻¹ is defined as G and a maximum peak intensity in a range of 1310 to 1350 cm⁻¹ is defined as D, a G/D ratio is 5 to 200.

7. The carbon nanotube dispersed liquid according to claim 1,
wherein, in a Bode plot obtained by an impedance measurement, in which reactance is plotted on a vertical axis and frequency is plotted on a horizontal axis, a minimal value of reactance exists in a frequency range of 170 to 600 kHz, and the minimum value of the reactance existing in the frequency range of 170 to 600 kHz is 1.8 times or more a value of reactance at a frequency of 1 kHz.

8. A carbon nanotube dispersed liquid, comprising:
a dispersion resin (A);
carbon nanotubes (B); and
water,
wherein the dispersion resin (A) contains a polar functional group-containing resin (a), and
in a Bode plot obtained by an impedance measurement, in which reactance is plotted on a vertical axis and frequency is plotted on a horizontal axis, a minimal value of reactance exists in a frequency range of 170 to 600 KHz.

9. The carbon nanotube dispersed liquid according to claim 8,
wherein, in the Bode plot obtained by the impedance measurement, in which reactance is plotted on a vertical axis and frequency is plotted on a horizontal axis, a minimal value of reactance exists in the frequency range of 170 to 600 kHz, and the minimum value of the reactance existing in the frequency range of 170 to 600 KHz is 1.8 times or more a value of reactance at a frequency of 1 kHz.

10. A carbon nanotube dispersed liquid according to claim 1, further comprising an electrode active material.

11. An electrode layer formed from the carbon nanotube dispersed liquid according to claim 10.

12. An electrode, comprising:
the electrode layer according to claim 11; and
a metal current collector.

13. A lithium ion battery comprising:
the electrode according to claim 12, as a positive electrode, a negative electrode, or both the positive electrode and the negative electrode.

14. A lithium ion battery comprising:
the electrode according to claim 12, as a positive electrode.

15. The carbon nanotube dispersed liquid according to claim 3,
wherein a degree of polymerization of the sulfonic acid-modified polyvinyl alcohol resin (a1-1) is 100 to 4,000, and
a degree of polymerization of the carboxylic acid-modified polyvinyl alcohol resin (a1-2) is 100 to 4,000.

16. The carbon nanotube dispersed liquid according to claim 2,
wherein the polar functional group-containing resin (a) contains the carboxymethyl celluloses (a2),
a weight-average molecular weight of the carboxymethyl celluloses (a2) is 5,000 to 500,000, and
a degree of etherification of the carboxymethyl celluloses (a2) is 0.5 to 1.5.

17. The carbon nanotube dispersed liquid according to claim 1,
wherein the carbon nanotubes (B) is a single-walled carbon nanotubes, a multi-walled carbon nanotubes, or a combination of the single-walled carbon nanotubes and the multi-walled carbon nanotubes.

18. The carbon nanotube dispersed liquid according to claim 1,
wherein an average value of outer diameters of the carbon nanotubes (B) is 0.5 to 30 nm,
an average value of lengths of the carbon nanotubes (B) is 1 to 100 μm, and
an average particle size (D50) of aggregates of primary particles of the carbon nanotubes (B) is less than 7 μm.

19. The carbon nanotube dispersed liquid according to claim 1,
wherein an initial viscosity of the carbon nanotube dispersed liquid is less than 15 Pa·s,
an absorbance of the carbon nanotube dispersed liquid at a wavelength of 268 nm is 1.3 or more, and
a ratio of a minimal value of a reactance in a frequency range of 170 to 600 kHz to a reactance at a frequency of 1 kHz, which is represented by a following expression, is more than 1.5 and 5.0 or less:
Ratio of minimal value of reactance to reactance at frequency of 1 kHz=[Minimal value of reactance in frequency range of 170 to 600 kHz]÷[Reactance at frequency of 1 kHz].

20. The carbon nanotube dispersed liquid according to claim 1,
in a case where an electrode layer is formed from the carbon nanotube dispersed liquid, a volume resistivity of the electrode layer is less than 12 Ω·cm.
